(19) United States
(12) Patent Application Publication
(10) Pub. No.: US 2020/0137456 A1
(43) Pub. Date: Apr. 30, 2020

(54) VIDEO MANAGEMENT SYSTEM FOR PROVIDING VIDEO MANAGEMENT OPERATIONS BASED ON VIDEO CREDITS SEGMENT DETECTION IN VIDEO

(71) Applicant: MICROSOFT TECHNOLOGY LICENSING, LLC, Redmond, WA (US)

(72) Inventors: Edan HAUON, Herzliya (IL); Ohad JASSIN, Tel Mond (IL); Daniel NURIELI, Herzliya (IL)

(21) Appl. No.: 16/169,994

(22) Filed: Oct. 24, 2018

(51) Int. Cl. H04N 21/466; H04N 21/435; H04N 21/472; H04N 21/845

(52) U.S. Cl. CPC H04N 21/4662; H04N 21/8456; H04N 21/47202; H04N 21/435

(57) ABSTRACT

Various methods and systems for performing video management operations based on video credits segment detection. Video management systems include different types of video-on-demand (“VOD”) providers that manage videos using the VOD system. In operation, a video credits segment detection machine-learning system is accessed. The video credits segment detection machine-learning system operates based on a video credits segment detection model that supports determining video credits segment detection scores that indicate a likelihood that segments of videos are video credits segments. The video credits segment detection model is generated based on a plurality of video credits segment detection features. A segment of a video is accessed. Using the video credits segment detection model, a video credits segment detection score for the segment is automatically determined. Based on the video credits segment detection score, a video management operation is executed to instruct on functionality available on the video management engine or video client.

### BACKGROUND

Users often rely on video or video systems as an electronic medium for the recording, copying, playback, broadcasting, and display of moving visual media. Video on demand (VOD) is a type of video system or video management system that allows users to select and watch or listen to video or audio content such as movies and TV shows whenever they choose, rather than at a scheduled broadcast time, the method that prevailed with over-the-air programming. Video systems can support a variety of video features on a variety of media, including radio broadcast, magnetic tape, optical discs, computer files, and network streaming. An example video feature may specifically be closing credits or end credits, which are a list of the cast and crew of a particular motion picture, television program, or video game. With the ever-increasing use of video systems, improvements in computing operations, such as managing video systems based on identifying video features in video, can yield a result that overrides the routine and conventional sequence of events ordinarily associated with the video features in the video.

### SUMMARY

Embodiments of the present invention relate to methods, systems, and computer storage media, for providing video management operations based on video credits segment detection. By way of background, video management systems provide support for executing video management operations using primarily marker-based models, which indicate a segment of video corresponding to video credits. For example, digital video files may include markers that indicate when video credits start, or alternatively, digital video files may include metadata (e.g., time codes) that correspond to different segments of the video, including a video credits segment. It can be tedious to manually implement marker-based models on all videos in a video management system library. As such, a comprehensive video management system with an alternative basis for executing video management operations can improve computing operations in video management systems.

In operation, a video credits segment detection machine-learning system of a video management system can be accessed, where the video credits segment detection machine-learning system operates based on a video credits segment detection model. Video management systems may include different types of video-on-demand (“VOD”) providers that manage and provide videos accessed using the VOD system. The video management system includes a video credits segment detection model that supports determining whether or not segments of videos are video credits segments of the videos. For example, video credits segment detection scores can be determined for corresponding videos, where the video credits segment detection scores indicate a likelihood that segments of videos are video credits segments of the videos. The video credits segment detection model is generated based on a plurality of video credits segment detection features that are explicitly and implicitly identified characteristics of single frames having video credits or multiple frames having video credits, which support defining the video credits segment detection model as a predictive model that determines whether or not the segment of the video is a video credits segment. A segment of video is then accessed, such that using the video credits segment detection model, an automatic determination of a video credits segment detection score for the segment of the video is made. Based on the video credits segment detection score, a video management operation is executed. The video management operations comprise instructions for performing functionality on the video management engine, a video client accessing the video, or on both.

As such, the embodiments described herein improve computing operations, functionality, and the technological process for performing video management operations based video credits segment detection. In particular, the ordered combination of steps, for determining a video credits segment of a video, specify how interactions with the video are manipulated to yield a desired result. In particular, the result overrides the routine and conventional sequence of events ordinarily triggered by the video credits segment, which further results in efficiency in user navigation of graphical user interfaces of video management systems.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an example video management system for performing video management operations, in which embodiments described herein may be employed;

FIG. 2. is an illustration of processing of a single frame for detecting a video credits segment of a video, in accordance with embodiments described herein;

FIG. 3 is an illustration of processing of multiple frames for detecting a video credits segment of a video, in accordance with embodiments described herein;

FIG. 4 is an illustration of video client interfaces performing video management operations, in accordance with embodiments described herein;

FIG. 5 is a flow diagram showing an example method for implementing a video management system with a video credits segment detection model, in accordance with embodiments described herein;

FIG. 6 is a flow diagram showing an example method for implementing a video management system with a video credits segment detection model, in accordance with embodiments described herein;

FIG. 7 is a flow diagram showing an example method for implementing a video management system with a video credits segment detection model, in accordance with embodiments described herein; and

FIG. 8 is a block diagram of an example computing environment suitable for use in implementing embodiments described herein.

### DETAILED DESCRIPTION

Video systems can support a variety of video features on a variety of media, including radio broadcast, magnetic tape, optical discs, computer files, and network streaming. Video on demand (VOD) is a type of video system that allows users to select and watch or listen to video or audio content, such as movies and TV shows whenever they choose, rather than at a scheduled broadcast time, the method that prevailed with over-the-air programming. An example video feature may specifically be closing credits or end credits that are a list of the cast and crew of a particular motion picture, television program, or video game. The video credits may also specifically be end of video rolling video credits (“rolling credits”) that scroll from a bottom portion to a top portion of a video display; rolling credits, as opposed to having multiple credits or names on a still frame, include movement, usually continuously rolling in a single direction.

In conventional video management systems, video management systems provide support for executing video management operations based primarily on marker-based models that indicate a segment of video corresponding to video credits. For example, digital video files may include markers that indicate when video credits start, or alternatively, digital video files may include metadata (e.g., time codes) that indicate different segments of the video including a video credits segment. However, such marker-based models have to be predefined for the video, and then saved in the video management system. For example, it is often the case that only videos native to a VOD system (e.g., NETFLIX produced content or HULU produced content) have support for additional video management operations based on the video credits segment of the video. In addition, non-native videos may not have access to the specific implementation of the marker-based model of the VOD system. Moreover, it can also be tedious to manually implement marker-based models on all videos in a video management system library. In this regard, performing video management operations may be limited only to select videos using the marker-based models, while excluding other types of videos that have not manually configured markers for video credits segments. As such, a comprehensive video management system with an alternative basis for executing video management operations can improve computing operations in video management systems.

Embodiments of the present invention are directed to simple and efficient methods, systems, and computer storage media for providing video management operations based on video credits segment detection. At a high level, video management operations are performed based on automatically detecting video credits segments for video. Video credits segments may refer to a single frame or multiple frames of video that are part of the video credits of the video. The video credits can specifically refer to rolling video credits at the end of a movie, where the video credits roll in a defined direction (e.g., from bottom-to-top) of the screen. Automatic detection of video credits segments can be distinguished from conventional detection mechanisms of video credits segments (e.g., marker-based models) in that, a machine-learning system supports the automated detection of video credits segments. In particular, the automated detection of video credits is based on a machine-learning predictive model (e.g., video credits segment detection model) that is trained on examples of single frames or multiple frames and their corresponding features to output whether or not a single frame or multiple frames are video credits segments.

Video credits segment detection features include explicitly and implicitly identified characteristics of single frames of video credits or multiple frames of video credits. The features support defining the video credits segment detection model as a predictive model that determines whether or not a segment of a video is a video credits segment. In particular, single frames or multiple frames are analyzed to extract corresponding features. For example, features may include histogram of colors, optical character recognition output for frames, relative time in the video, relative frames, audio elements, sound signature, subtitle files, and video metadata where different types of features correspond to the single frame, multiple frames, or both. The features may be programmatically defined and organized to be retrieved for machine-learning, as discussed herein in more detail. In this regard, a selected feature of the single frame features or the multiple frame features is a relevant characteristic corresponding to the single frame or the multiple frames, where the features are further used in the machine-learning system for developing the video credits segment detection model, as discussed herein in more detail.

By way of background, a machine-learning system may include machine-learning tools and training components. Machine-learning systems can include machine-learning tools that are utilized to perform operations in different types of technology fields. Machine-learning systems can include pre-trained machine-learning tools that can further be trained for a particular task or technological field. At a high level, machine-learning is a field of study that gives computers the ability to learn without being explicitly programmed. Machine-learning explores the study and construction of machine-learning tools, including machine-learning algorithm or models, which may learn from existing data and make predictions about new data. Such machine-learning tools operate by building a model from example training data in order to make data-driven predictions or decisions expressed as outputs or assessments. Although example embodiments are presented with respect to a few machine-learning tools, the principles presented herein may be applied to other machine-learning tools. It is contemplated that different machine-learning tools may be used, for example, Logistic Regression (LR), Naive-Bayes, Random Forest (RF), neural networks (NN), matrix factorization, and Support Vector Machines (SVM) tools may be used for addressing problems in different technological fields.

In general, there are two types of problems in machine-learning: classification problems and regression problems. Classification problems, also referred to as categorization problems, aim at classifying items into one of several category values (for example, is this email SPAM or not SPAM). Regression algorithms aim at quantifying some items (for example, by providing a value that is a real number). Machine-learning algorithms can provide a score (e.g., a number from 1 to 100) to qualify one or more products as a match for a user of the online marketplace.

Machine-learning algorithms utilize the training data to find correlations among identified features (or combinations of features) that affect an outcome. A trained machine-learning model may be implemented to perform a machine-learning operation based on a combinations of features. An administrator of a machine-learning system may also determine which of the various combinations of features are relevant (e.g., lead to desired results), and which ones are not. The combinations of features determined to be (e.g., classified as) successful are input into a machine-learning algorithm for the machine-learning algorithm to learn which combinations of features (also referred to as “patterns”) are “relevant” and which patterns are “irrelevant.” The machine-learning algorithms utilize features for analyzing the data to generate an output or an assessment. A feature can be an individual measurable property of a phenomenon being observed. The concept of feature is related to that of an explanatory variable used in statistical techniques such as linear regression. Choosing informative, discriminating, and independent features is important for effective operation of the machine-learning system in pattern recognition, classification, and regression. Features may be of different types, such as numeric, strings, and graphs.

The machine-learning algorithms utilize the training data to find correlations among the identified features that affect the outcome or assessment. The training data includes known data for one or more identified features and one or more outcomes. With the training data and the identified features the machine-learning tool is trained. The machine-learning tool determines the relevance of the features as they correlate to the training data. The result of the training is the trained machine-learning model. When the machine-learning model is used to perform an assessment, new data is provided as an input to the trained machine-learning model, and the machine-learning model generates the assessment as output.

The video credits segment detection model is trained to classify the video frames based on a variety of different features. A machine-learning system having the video credits segment detection model may facilitate determining whether or not segments of videos are video credits segments of the videos. The video credits segment detection model is generated based on a plurality of video credits segment detection features. The plurality of video credits segment detection features include explicitly and implicitly identified characteristics of single frames of video credits or multiple frames of video credits. For example, for a single frame a feature may include expected texts and positions of OCR characters, while for a multiple frames a feature may include expected texts and progressive locations across the multiple frames of OCR characters. Further for single frames, no sound signature feature may exist, while multiple frames may include a sound signature feature across frames.

Other variations and combinations of single frame features and multiple frames features that characterize the measurable properties of rolling credits existing in a single frame or rolling credits existing across multiple frames, respectively, are contemplated with embodiments described herein. By way of example, video files can be associated with subtitle files. Video files can also be associated with video metadata that further describe aspects of the video. Video files also include audio tracks that include different types of audio elements associated with the video and corresponding single frames or multiple frames. As such, each of the above-identified features of video may be identified as single frame features or multiple frame features for training the video credits segment detection model. It is further contemplated that the specific content within these features (i.e., extracted sub-features) may also be identified for training. For example, a video having a subtitle file, where the subtitle file is a feature that is used to detect video credit segments, can also have the extracted sub-features (e.g., characteristics of the subtitle file including format, content, length, and file source) of the subtitle file can further be used for training the video credits segment detection model. Accordingly, the single frame features and multiple frame features, through training, support defining the video credits segment detection model as a predictive model that determines whether or not the segment of the video is a video credits segment.

The machine-learning algorithms utilize features for analyzing the data to generate an output or an assessment. The machine-learning algorithms utilize the video credits segment detection training data to find correlations among the identified features that affect the outcome or assessment. The training data includes known data for one or more identified features (e.g., single frame features or multiple frames features) and one or more outcomes (e.g., “is a video credits segment or is not a video credits segment”). With the training data and the identified features, the machine-learning tool is trained. For example, the training data may include video segments from a video database, where the video segments are retrieved either as single frames or multiple frames for training the model to make a determination on either single frame inputs or multiple frames inputs as new data. It is contemplated processing single frames or multiple frames as input into the model may be executed at any given time when the model is defined. Additionally, the model can be continually retrained or periodically retrained to improve on the efficiency and results in determine whether or not single frames or multiple frames are video credits segments of video. In this regard, video management systems may implement this invention in order to circumvent marker-based models for detecting video credits but instead implement machine-learning-based automated detection of video credits for different types of video content.

Several different types of optimizations may be implemented for performing video management operations based on video credits segment detection. Optimizations may generally refer to additional techniques that can be selectively implemented to improve on the performance of the machine-learning model performance or the runtime performance of the functionality described herein. For example, the machine-learning model may further be implemented along with smoothing functions to reduce misdetection of rolling credits single frames or multiple frames; classification of a set of n single frames, classification of a set of m multiple frames sets, classification of a set of n single frames and m multiples frames, embedding and weighting different types of single frame features or multiple frame features, may all be implemented using the machine-learning model to optimize performance.

Runtime performance optimizations may include performing exclusively binary searches on single frames or multiple framesets for faster processing of outputs whether a single frame or multiple frames are or are not video credits segments. In addition, for a video being detected for video credits segments, processing the video segment through the video credits segment detection model may be executed in reverse order or backwards from the end of the video until a video credits segment is detected. Processing the video segment in this manner may also include only accessing a limited percent (e.g., K %) of the video. It contemplated that processing in reverse order may further include iteratively processing backwards to identify a first video segment of the video that includes the video credits. Additionally a combination of forwards and backwards processing through the video credits segment detection model may be performed to accelerate the detection of video credits segments.

Video credits segment detection model performance and runtime performance can be executed alone or in combination to improve the accuracy and efficiency in video credits segment detection. For example, a first video credits segment detection score may be determined for a single frame, where the single frame meets a threshold score for further processing a multiple frames set including the single frame but not a threshold score that the single frames is conclusively a video credits segment. Further processing of the multiple frames, including the single frame, may be performed to determine a second video credits segment detection score, which may or may not be dispositive of the final determination that the multiple frames are a video credits segment. It is further contemplated that based on the second video credits segment detection score, a prompt (i.e., a video management operation) may be generated to receive input on whether a current segment of the video includes video credits and then based on input received in response to the prompt, an additional video management operation may be performed. For example, if the response indicates that the video segment includes video credits, then the additional video management operation is performed; however, if the response indicates that the video segment does not include video credits, then the additional video management operation is not performed and the video continues playing. Advantageously, the accuracy and efficiency of video credits segment detection may be improved based on variations and combination of video credits segment detection model and runtime model performance optimizations.

The video management system also includes a video management operations manager that is responsible for performing video management operations upon detecting a video credits segment of video. In particular, the video management operation may be performed for a video client accessing the video that includes the segment of the video credits. Several different techniques may be used for as part of executing the video management operations. For example, the video while being accessed or upon being transferred may be associated with metadata, code file, or program that identifies that video and the video credits segment such that when the video is being played back and the video is at or proximate to the video credits segment a corresponding video management operation can be performed.

At a high level, several different types of video management operations can be performed: a first video management operation that instructs on functionality on the video management engine of the video; a second video management operation that instructs on functionality on a video client accessing the video; and a third video management operation that instructs on functionality on both the video management engine of the video and the video client accessing the video. For example, video management operations may include providing a survey or soliciting a rating about video, providing a prompt to perform or select defined actions associated with a user profile of the video management system, minimizing video, muting the audio, making a recommendation about another show to watch, shutdown or stop playing video or shut off the machine or WiFi or turn off high-speed processing, switch to power-saving, more efficient running, preserve battery or conserve bandwidth or data connection for the user. In one embodiment, the video management operation may be include causing generation of a video credit segment indicator icon on a progress bar on a video client accessing the video. The video credit segment indicator icon is generated at on the progress location proximate a video credits segment of the video. In this regard, a user may visual observe where the video credits segment begins which is different from movie duration. Other variations and combinations of video management operation are contemplated with embodiments of the present invention.

Embodiments of the present invention have been described with reference to several inventive features (e.g., operations, systems, engines, and components) associated with a video management system having a video credits segment detection model. Inventive features described include: operations for training the video credits segment detection model based on single frame features and multiple frame features to output a classification for a single frame or multiple frames processed through the video credits segment detection model. The output can indicate whether or not a segment of video is a video credits segment or a likelihood (e.g., a video credits segment detection score) that the segment is a video credits segment.

Functionality of the embodiments of the present invention have further been described, by way of an implementation and anecdotal examples, to demonstrate that the operations for providing video management operations, based on video credits segment detection, are an unconventional ordered combination of operations that operate with a video management engine as a solution to a specific problem in video management technology environments to improve computing operations and user interface navigation in video management systems. Advantageously, the embodiments described herein improve the computing operations, functionality, and the technological process for providing the functionality described herein. Overall, these improvements result in less CPU computation, smaller memory requirements, and increased flexibility in video management systems.

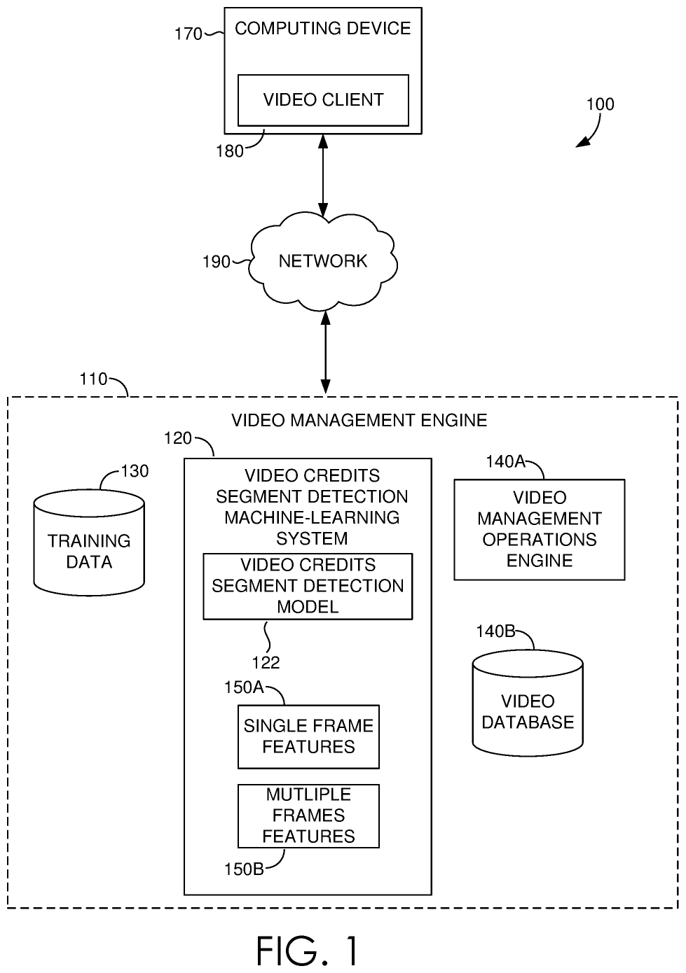

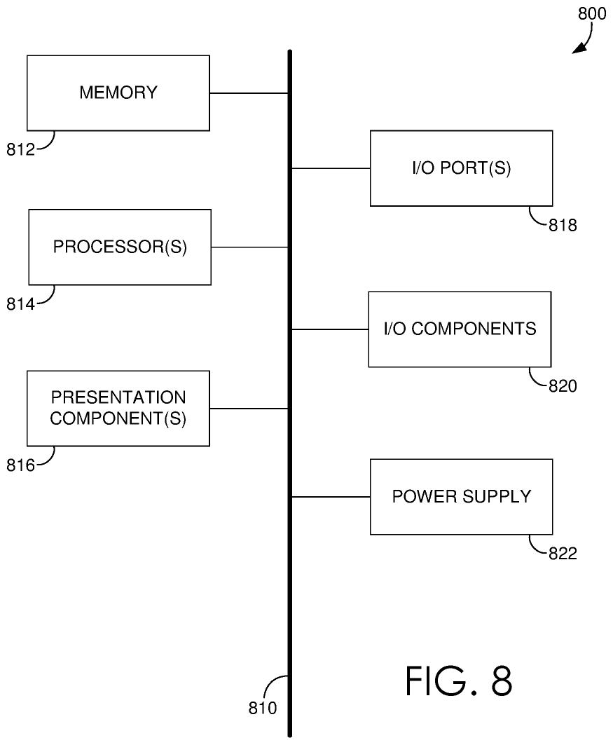

With reference to FIG. 1, FIG. 1 illustrates an example video management system 100 in which implementations of the present disclosure may be employed. In particular, FIG. 1 shows a high level architecture of video management system 100 having components in accordance with implementations of the present disclosure. Among other components, managers, or engines not shown, video management system 100 includes a computing device 170 having a video client 180. The computing device 170 communicates via a network 190 with a video management engine 110. The video management engine 110 includes video credits segment detection machine-learning system 120 having a video credits segment detection model 122, training data 130, video management operations engine solution 140A and video database 140B. The video credits segment detection machine-learning system 120 further includes single frames 150A and multiple frames feature 150B. The components of the video management system 100 may communicate with each other over one or more networks (e.g., public network or virtual private network “VPN”) as shown with network 190. The network 190 may include, without limitation, one or more local area networks (LANs) and/or wide area networks (WANs). The computing device 170 may be a client computing device that corresponds to the computing device described herein with reference to FIG. 8.

The components of the video management system 100 may operate together to provide functionality for performing video management operations based on video credits segment detection, as described herein. The video management system 100 supports processing requests from the computing device 170. In particular, the computing device 170 may receive a request (e.g., a video access request to access a video) and communicate the request to the video management engine 110. The computing device 170 may also receive videos (e.g., video data) from the video management engine 110 and display or cause display of the videos. The video management engine 110 is responsible for performing video management operations for video at the video management engine 110. Video data may include different types and formats of video data having an identifier, or additional related data and metadata associated with the video management system, where video data is processed for playback on a video client (e.g., video client 180). The video management engine 110 may receive requests for videos, such that the videos are played at the client including a video credits segment of the video.

Video management engine 110 is responsible for performing video management operations based on video credits segment detection. The video management engine 110 operates based on the video credits segment detection model 122 that supports determining whether or not segments of videos are video credits segments of the videos. The video credits segment detection model 122 is generated based on a plurality of video credits segment detection features. Determining whether or not segments of videos are video credits segments of the videos, can based on video credits segment detection scores that indicate a likelihood that segments of videos are video credits segments of the videos.

The video management engine 110 accesses a segment of a video. The segment of video can be accessed from the video database 140B. The video database 140B may store and provide access to different types of video and in particular, provide access to a video that has been requested for playback at a video client.

It is contemplated that the video management engine 110 may access the segment of the video at any time and in different ways. For example, the segment of the video may be accessed based on a request of the video, or the segment of the video may be accessed while the video is being played. Also, accessing the segment of the video may include accessing a subsection of the video. The subsection of the video may be at an end portion of the video. Moreover, the subsection of the video may be iteratively processed to determine a starting point of video credits in the video to provide runtime performance optimization.

Additionally, the video may be accessed such that the functionality described herein is pre-executed during offline processing and an index entry (e.g., a time code of the video credits segment) is generated in association with the video. Thus, the index entry is referenced for the video credits segment for performing video management operations corresponding to the video credits segment, whenever the video is accessed. In this regard, the video database may operate to store the video and the corresponding index entry for the machine-learning-based pre-identified video credits segment of the video.

The video management engine 110 is responsible for using the video credits segment detection model 122, to automatically determine whether or not the segment of the video is a video credits segment of the video. The video credits segment detection model 122 is part of the video credits segment detection machine-learning system 120 that trains the video credits segment detection model 122 using training data 130 and single frame features 150A and multiple frame features 150B. The plurality of video credits segment detection features include explicitly and implicitly identified characteristics of single frames having video credits or multiple frames having video credits that support defining the video credits segment detection model 122 as a predictive model that determines whether or not the segment of the video is a video credits segment. The explicitly and implicitly identified characteristics of single frames having video credits or multiple frames having video credits may specifically be associated with rolling video credits that scroll or roll from a bottom portion to a top portion of a video display.

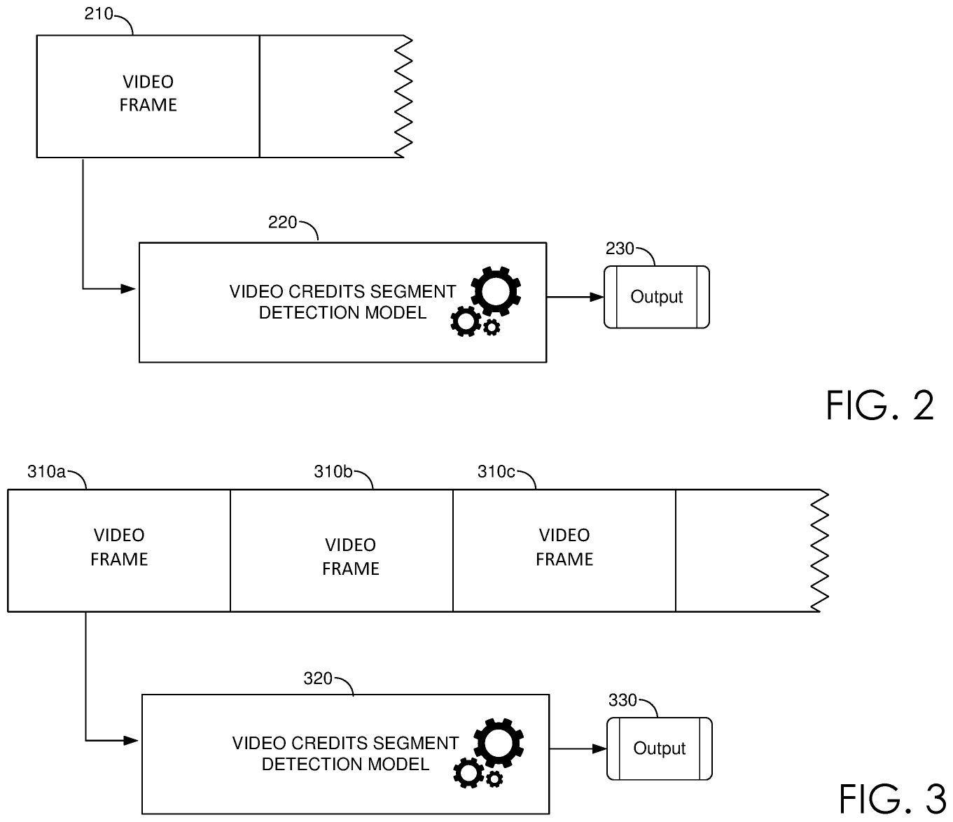

By way of illustration, with reference to FIG. 2, a plurality of video credits segment detection features are associated with single frame features, where the segment of the video is a single frame (e.g., video frame 210) is processed through the video credits segment detection model 220 to generate a video credits segment detection score (e.g., output 230) to classify or not classify the segment of the video as a video credits segment. With reference to FIG. 3, a plurality of video credits segment detection features are associated with multiple frames features (e.g., video frame 310a, video frame 310b and video frame 310c), where the segment of the video is multiple frames that are processed through the video credits segment detection model 320 to generate a video credits segment detection score (e.g., output 330) to classify or not classify the segment of the video as a video credits segment.

The video management engine 110 via the video management operations engine 140A is also responsible for executing a video management operations based on determining that the segment of the video is a video credits segment of the video or based on the video credits segment detection score. Executing the video management operations includes executing at least one of the following: a first video management operation that instructs on functionality on a video management system of the video; a second video management operation that instructs on functionality on a video client accessing the video; and a third video management operation that instructs on functionality on both the video management engine of the video and the video client accessing the video.

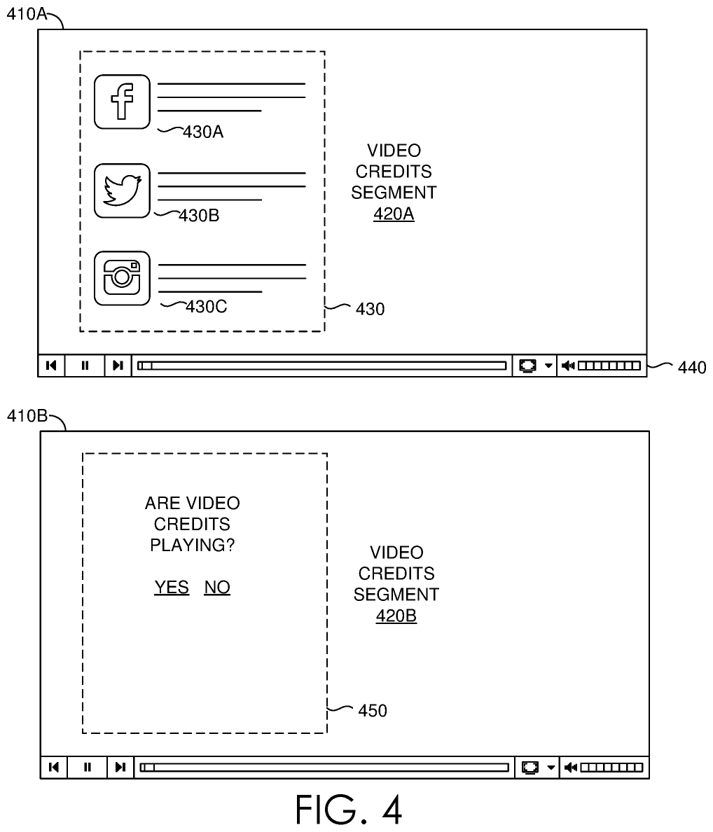

Embodiments of the present invention may further be described with reference to FIG. 4 that provides illustrations of operations with reference to user interfaces associated with components of the video management system 100. At a high level, the operations and user interfaces support improving computer operations based on improving providing video management operations using video credits segment detection. Additionally, the video management engine 110 allows for user interface interaction models that use the components of the video management system to provide novel user interfaces as described in more detail below.

FIG. 4 includes the video client interface 410A, video credits segment 420A, video management operation graphic 430 (i.e., 430A, 430B and 430C) and video management operation graphic 440. FIG. 4 further includes the video client interface 410B, video credits segment 420B, video management operation graphic 450. With reference to video client interface 410A, video client interface 410A includes the video management operation graphic 430 that is generated based on detecting video credits segment 420A for a video playing on the video client interface 410A. The video management operation graphic 440 is associated with another video management operation, also performed based on detecting the video credits segment 420A. The video credits segment 420A is detected based on methods described herein. The video management operation graphic 430 may be an example video generation operation associated with both the video management system and the video client device, where the video management operation instructs the video management system to generate social media icons associated with social media programs, so that social media operations can be performed. The video management operation 440 may be an example video generation operation associated with the video client device, where the video management operation instructs the video client device to reduce the volume on the video client device. Other variations and combinations of video management operations based on detecting a video credits segment are contemplated with embodiments of the present invention.

With reference to video client interface 410B, video client interface 410B includes the video management operations graphic 450 that is generated based on detecting video credits segment 420B for a video playing on the video client interface 420B. The video credits segment 420B is detected based on methods described herein. The video management operation graphic 450 may be an example video generation operation associated with video credits segment detection model performance and runtime performance optimization. The video generation operation is a prompt generated to receive input on whether a current segment of the video includes video credits and then based on the input received in response to the prompt, an additional video management operation may be performed. The video management operation graphic 450 is generated in response to a video credits segment detection output or combination of outputs (e.g., scores or combination of scores) at a threshold score that trigger generating a prompt for further input from a user. Advantageously, the accuracy and efficiency of video credits segment detection may be improved based on the user prompt response and other variations and combinations of video credits segment detection model and runtime model performance optimizations.

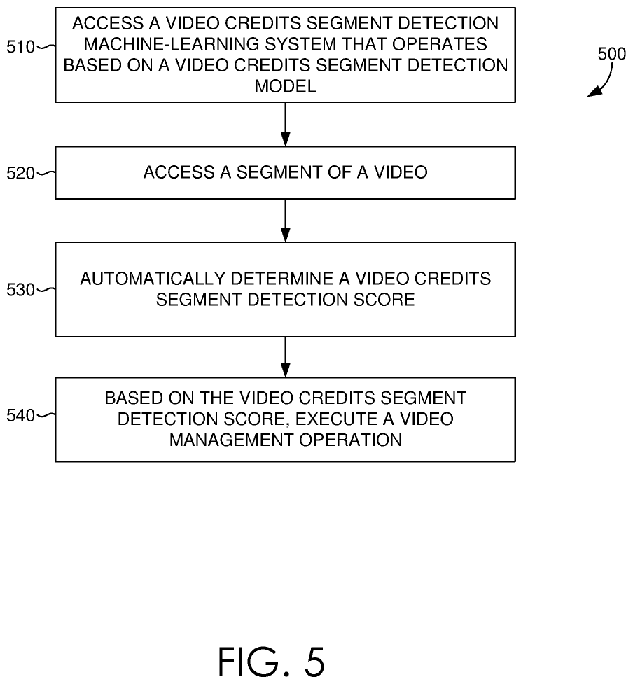

With reference to FIGS. 5, 6, and 7, flow diagrams are provided illustrating methods for implementing a video management system for providing video management operations based on video credits segment detection. The methods may be performed using the video management system described herein. In embodiments, one or more computer storage media having computer-executable instructions embodied thereon that, when executed, by one or more processors can cause the one or more processors to perform the methods in the video management system.

Turning to FIG. 5, a flow diagram is provided that illustrates a method 500 for implementing a video management system for performing video management operations based on a video credits segment detection. Initially at block 510, a video credits segment detection machine-learning system is accessed. The video credits segment detection machine-learning system operates based on a video credits segment detection model that supports determining video credits segment detection scores that indicate a likelihood that segments of videos are video credits segments of the video. The video credits segment detection model is generated based on a plurality of video credits segment detection features. At block 520, a segment of a video is accessed. At block 530, using the video credits segment detection model, a video credits segment detection score for the segment of the video is automatically determined. At block 540, based on the video credits segment score, a video management operation is executed.

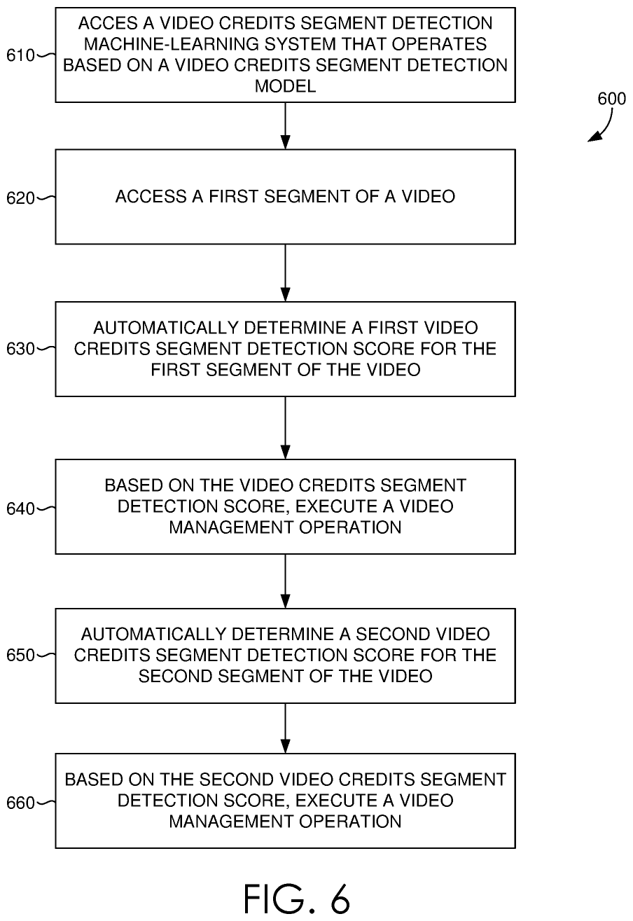

Turning to FIG. 6, a flow diagram is provided that illustrates a method 600 for implementing a video management system for performing video management operations based on a video credits segment detection. Initially at block 610, a video credits segment detection machine-learning system is accessed. The video credits segment detection machine-learning system operates based on a video credits segment detection model that support determining video credits segment detection scores that indicate a likelihood that segments of videos are video credits segments of the video. The video credits segment detection model is generated based on a plurality of video credits segment detection features.

At block, 620, a first segment of a video is accessed. The first segment is a single frame of the video. At block 630, using the video credits segment detection model, a first video credits segment detection score for the first segment of the video is automatically determined. At block 640, based on the first video credits segment detection score, a second segment of the video is accessed. The second segment is multiple frames of the video comprising the first segment of the video. At block 650, using the video credits segment detection model, a second video credits segment detection score for the second segment of the video is automatically determined. At block 660, based on the second video credits segment detection score, a video management operation is executed.

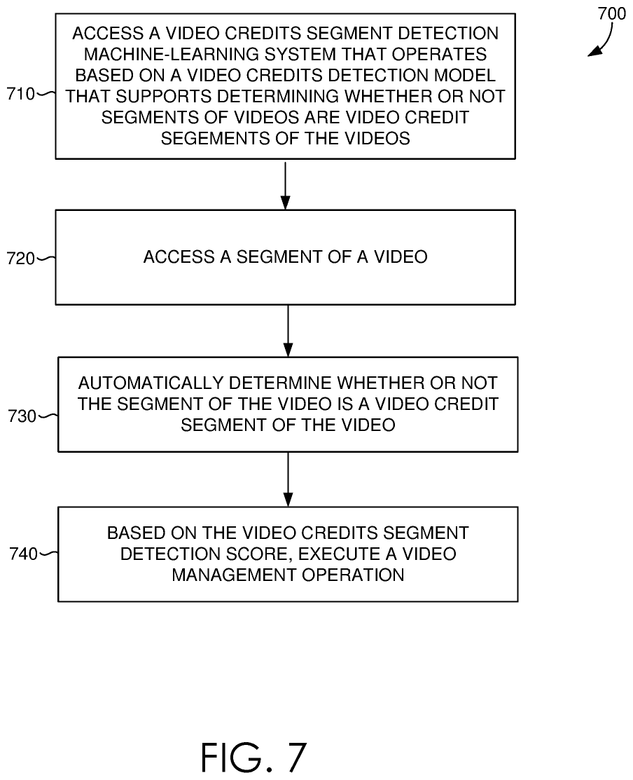

Turning to FIG. 7, a flow diagram is provided that illustrates a method 700 for implementing a video management system for performing video management operations based on a video credits segment detection. Initially at block 710, a video credits segment detection machine-learning system is accessed. The video credits segment detection machine-learning system operates based on a video credits segment detection model that supports determining whether or not segments of videos are video credits segments of the videos. The video credits segment detection model is generated based on a plurality of video credits segment detection features. At block 720, a segment of a video is accessed. At block 730, using the video credits segment detection model, an automatic determination is made whether or not the segment of the video is a video credits segment of the video. At block 740, based on determining that the segment of the video is a video credits segment of the video, a video management operation is executed.

With reference to the video management system 100, embodiments described herein support performing video management operations based on video credits segment detection. The video management system components refer to integrated components that implement the image video management system. The integrated components refer to the hardware architecture and software framework that support functionality using the video management system components. The hardware architecture refers to physical components and interrelationships thereof and the software framework refers to software providing functionality that may be implemented with hardware operated on a device. The end-to-end software-based video management system may operate within the other components to operate computer hardware to provide video management system functionality. As such, the video management system components may manage resources and provide services for the video management system functionality. Any other variations and combinations thereof are contemplated with embodiments of the present invention.

By way of example, the video management system may include an API library that includes specifications for routines, data structures, object classes, and variables may support the interaction the hardware architecture of the device and the software framework of the video management system. These APIs include configuration specifications for the video management system such that the components therein may communicate with each other for form generation, as described herein.

With reference to FIG. 1, FIG. 1 illustrates an example video management system 100 in which implementations of the present disclosure may be employed. In particular, FIG. 1 shows a high level architecture of video management system 100 having components in accordance with implementations of the present disclosure. It should be understood that this and other arrangements described herein are set forth only as examples. In addition, a system, as used herein, refers to any device, process, or service or combination thereof. As used herein, engine is synonymous with system unless otherwise stated. A system may be implemented using components or generators as hardware, software, firmware, a special-purpose device, or any combination thereof. A system may be integrated into a single device or it may be distributed over multiple devices. The various components or generators of a system may be co-located or distributed. For example, although discussed for clarity as the content application component, operations discussed may be performed in a distributed manner. The system may be formed from other systems and components thereof. It should be understood that this and other arrangements described herein are set forth only as examples.

Having identified various component of the video management system 100, it is noted that any number of components may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Further, although some components of FIG. 1 are depicted as single components, the depictions are example in nature and in number and are not to be construed as limiting for all implementations of the present disclosure. The video management system 100 functionality may be further described based on the functionality and features of the above-listed components.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Having described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should the computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes a bus 810 that directly or indirectly couples the following devices: memory 812, one or more processors 814, one or more presentation components 816, input/output ports 818, input/output components 820, and an illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Example hardware devices include solid-state memory, hard drives, optical-disc drives, etc. Computing device 800 includes one or more processors that read data from various entities such as memory 812 or I/O components 820. Presentation component(s) 816 present data indications to a user or other device. Example presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters” using communication media described herein. Also, the word “initiating” has the same broad meaning as the word “executing or “instructing” where the corresponding action can be performed to completion or interrupted based on an occurrence of another action. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely examples. Components can be configured for performing novel aspects of embodiments, where the term “configured for” can refer to “programmed to” perform particular tasks or implement particular abstract data types using code. Further, while embodiments of the present invention may generally refer to the video management system and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A computer-implemented for performing video management operations based on video credits segment detection, the method comprising:
accessing a video credits segment detection machine-learning system, the video credits segment detection machine-learning system operates based on a video credits segment detection model that supports determining video credits segment detection scores that indicate a likelihood that segments of videos are video credits segments of the videos, wherein the video credits segment detection model is generated based on a plurality of video credits segment detection features;
accessing a segment of a video;
using the video credits segment detection model, automatically determining a video credits segment detection score for the segment of the video; and
based on the video credits segment detection score, executing a video management operation.

2. The method of claim 1, wherein the plurality of video credits segment detection features comprise explicitly and implicitly identified characteristics of single frames comprising video credits or multiple frames comprising video credits that support defining the video credits segment detection model as a predictive model that determines whether or not the segment of the video is a video credits segment.

3. The method of claim 2, wherein the explicitly and implicitly identified characteristics of single frames comprising video credits or multiple frames comprising video credits are associated with rolling video credits that scroll from a bottom portion to a top portion of a video display.

4. The method of claim 2, wherein the plurality of video credits segment features includes a first feature associated with an extracted sub-feature, wherein the extracted sub-feature further defines the video credits segment detection model, wherein the first feature is a subtitle file having the extracted sub-feature.

5. The method of claim 1, wherein the plurality of video credits segment detection features are associated with single frame features, wherein the segment of the video is a single frame that is given the video credits segment detection score to classify the segment of the video as a video credits segment; and
wherein the plurality of video credits segment detection features are associated with multiple frames video credits features, wherein the segment of the video is multiple frames that is given the video credits segment detection score to classify the segment of the video as a video credits segment.

6. The method of claim 1, wherein the accessing the segment of the video comprising access a subsection of the video, wherein the subsection of the video is an end portion of the video that is iteratively processed to determine a starting point of video credits in the video.

7. The method of claim 1, wherein executing the video management operation comprises executing at least one of the following:
a first video management operation that instructs on functionality on a video management system of the video;
a second video management operation that instructs on functionality on a video client accessing the video; and
a third video management operation that instructs on functionality on both the video management engine of the video and the video client accessing the video.

8. One or more computer storage media having computer-executable instructions embodied thereon that, when executed, by one or more processors, cause the one or more processors for performing video management operations based on video credits segment detection, the method comprising:
accessing a video credits segment detection machine-learning system, the video credits segment detection machine-learning system operates based on a video credits segment detection model that supports determining video credits segment detection scores that indicate a likelihood that segments of videos are video credits segments of the videos, wherein the video credits segment detection model is generated based on a plurality of video credits segment detection features;
accessing a first segment of a video, wherein the first segment is a single frame of the video;
using the video credits segment detection model, automatically determining a first video credits segment detection score for the first segment of the video;
based on the first video credits segment detection score, accessing a second segment of the video, wherein the second segment is multiple frames of the video comprising the first segment of the video;
using the video credits segment detection model, automatically determining a second video credits segment detection score for the second segment of the video; and
based on the second video credits segment detection score, executing a video management operation.

9. The media of claim 8, wherein the plurality of video credits segment detection features comprise explicitly and implicitly identified characteristics of single frames comprising video credits or multiple frames comprising video credits that support defining the video credits segment detection model as a predictive model that determines whether or not the segment of the video is a video credits segment,
wherein the plurality of video credits segment features includes a first feature associated with an extracted sub-feature, wherein the extracted sub-feature further defines the video credits segment detection model.

10. The media of claim 8, wherein the accessing the first segment of the video comprises accessing a subsection of the video, wherein the subsection of the video is an end portion.

11. The media of claim 8, wherein the first video credits segment detection score for the segment of the video meets a threshold video credits segment detection score that triggers accessing the second segment of the video comprising multiple frames including the first segment of the video.

12. The media of claim 8, wherein the plurality of video credits segment detection features are associated with single frame features, wherein the segment of the video is a single frame that is given the video credits segment detection score to classify the segment of the video as a video credits segment; or
wherein the plurality of video credits segment detection features are associated with multiple frames video credits features, wherein the segment of the video is multiple frames that is given the video credits segment detection score to classify the segment of the video as a video credits segment.

13. The media of claim 8, wherein executing the video management operation comprises causing generation of a video credit segment indicator icon on a progress bar on a video client accessing the video, wherein the video credit segment indicator icon is generated on the progress location proximate a video credits segment of the video.

14. The media of claim 8, wherein executing the video management operation comprises causing generation of a prompt requesting an input indicating whether or not the current video segment is a video credits segment of the video.

15. A video management system for performing video management operations based on video credits segment detection, the system comprising:
one or more processors; and
one or more computer storage media storing computer-useable instructions that, when used by the one or more processors, cause the one or more processors to execute:
a video management engine:
accessing a video credits segment detection machine-learning system, the video credits segment detection machine-learning system operates based on a video credits segment detection model that supports determining whether or not segments of videos are video credits segments of the videos, wherein the video credits segment detection model is generated based on a plurality of video credits segment detection features;
accessing a segment of a video;
using the video credits segment detection model, automatically determine whether or not the segment of the video is a video credits segment of the video; and
based on determining that the segment of the video is a video credits segment of the video, executing a video management operation for a video client accessing the video.

16. The system of claim 15, wherein determining whether or not segments of videos are video credits segments of the videos is based on video credits segment detection scores that indicate a likelihood that segments of videos are video credits segments of the videos.

17. The system of claim 15, wherein executing the video management operation comprises providing a prompt requesting an input indicating whether or not a current video segment of the video is a video credits segment of the video; and
based on receiving the input indicating that the current video segment of the video is or is not a video credits segment of the video, executing another video management operation.

18. The system of claim 15, further comprising a video credits segment detection machine-learning system configured to:
train the video credits segment detection model, based on the plurality of video credits segment detection features, to receive the segment as a single frame or as multiple frames and generate an output; and
wherein the plurality of video credits segment detection features comprise explicitly and implicitly identified characteristics of single frames comprising video credits or multiple frames comprising video credits that support defining the video credits segment detection model as a predictive model that determines whether or not the segment of the video is a video credits segment.

19. The system of claim 15, wherein the plurality of video credits segment detection features are associated with single frame features, wherein the segment of the video is a single frame that is given the video credits segment detection score to classify the segment of the video as a video credits segment; or
wherein the plurality of video credits segment detection features are associated with multiple frames video credits features, wherein the segment of the video is multiple frames that is given the video credits segment detection score to classify the segment of the video as a video credits segment.

20. The system of claim 15, the system further comprising a video management operations engine configured to execute the video management operation, wherein executing the video management operations comprises executing at least one of the following:
a first video management operation that instructs on functionality on the video management engine of the video;
a second video management operation that instructs on functionality on the video client accessing the video; and
a third video management operation that instructs on functionality on both the video management engine of the video and the video client accessing the video.
